(19) United States
(12) Patent Application Publication
(10) Pub. No.: US 2011/0155324 A1
(43) Pub. Date: Jun. 30, 2011

(54) CUTTING DEVICE FOR LABEL PRINTER

(75) Inventors: Feng-Yi Tai, Chung-Ho City (TW); Ching-Yang Chou, Chung-Ho City (TW)

(73) Assignee: GODEX INTERNATIONAL CO., LTD., Chung-Ho City (TW)

(21) Appl. No.: 12/648,301

(22) Filed: Dec. 29, 2009

(51) Int. Cl. B26D 5/26

(52) U.S. Cl. 156/354; 156/522

(57) ABSTRACT

A cut device for a label printer is a cut device installed in front of a main body of a label printer; it mainly includes: a base, an accepting space being indented on the top end thereof and a long slot being opened on the face thereof; a fixed type cutting tool, installed under the long slot; a movable cutting tool, installed below the accepting space of the base and positioned above the long slot; an acting mechanism, received in the accepting space of the base, the bottom thereof being connected with the movable cutting tool; after a label paper is output from the main body to the long slot of said base, the acting mechanism drives the movable cutting tool connected thereto to move downward to contact with the fixed type cutting tool face to face by pressing the acting mechanism such that the label paper is cut off. Furthermore, a sensor, used for detecting, receiving and confirming whether the label paper is drawn out or not after the completion of the transfer printing so as to transmit and execute next paper feeding command action.

### BACKGROUND OF THE INVENTION

1. Field of the Invention

The present invention relates to a cutting device for a label printer, and more particularly to a cutting device configured on every kind of label printer and capable of being reused.

2. Description of Related Art

The current label printer is broadly used on bar codes, labels, transportation self adhesive paper or every kind of label used for indication on factory production lines. But, the current conventional market available label printers are automatic label printers, each of which includes a main base station, data generator, carbon tape holder, printer head, cut mechanism and etc. The data generator will receive data and transmit it to the printer head after the data is input, and the printer head and carbon tape holder will print the data on label papers by means of transfer printing, and each label paper of the data transfer printing will then be cut off by the cut mechanism immediately after the data input is completed; this process is a full automatic operation so as to save time. But, the label printer is not a machine used for long term and mass production and needing for frequent use; the internal of a microcomputer appears a short circuit to cause many wrong messages after a long term use; the most common is that a label paper is cut off even if not being output completely.

Many label printers with a different specification and module are designed depending on needs at the present. No matter what kind of specification the label printer is applied to, it needs a cut mechanism anyway such that manufactured label can then assume a complete product.

The cut mechanism not only is used for cutting-but needs to provide the eye appealing outlook of a product such that a cutting tool of the cut mechanism usually is made from a particular material, thereby ensuring that the completeness of the product cutting. Besides, the material can further increase the life of a cutting tool, and is usually used on label printers by the inventor of the present invention. But, the unit price of the cutting tool made from it is higher than a general cutting tool such that the cost of the label printer is increased; a consumer always decides to buy a label printer with only one single specification and uses it on every kind of different requirement such that the life of the label printer is decreased because the unit price thereof is too high to cause a burden on the consumer even if the consumer needs to buy a label printer with many specifications.

Furthermore, when a user replaces and purchases the same kind of label printer, although the cut mechanism in the old machine usually is still in a good condition and can still be used, the user is forced to buy the cut mechanism accompanying a main body because elements of a conventional full automatic label printer are connected and drived relatively due to the integrated design thereof. Therefore, not only a cutting tool of the cut mechanism is wasted but the purchasing cost becomes higher.

### SUMMARY OF THE INVENTION

To improve the deficits mentioned above, the present invention is proposed. The present invention provides a cut device of a label printer, mainly comprising a base, on which a fixed type cutting tool is fixed, and indented with an accepting space for receiving an acting mechanism, a bottom of the acting mechanism being connected to a movable cutting tool, whereby the movable cutting tool is acted downward to contact with the fixed type cutting tool face to face so as to cut off a label paper.

The acting mechanism exerts a force on the movable cutting tool uniformly, enabling the movable cutting tool to carry out a stable movement, thereby increasing the life of the movable cutting tool and the acting mechanism. Besides, the structure of the acting mechanism is simple, the assembly thereof is easy, thereby increasing the production efficiency effectively.

Further, a front end of a main body has at least two locking holes; left and right ends of a lower housing plate are extended with at least two retaining holes, the cut device can be installed in front of the main body of any kind of label printer by passing locking elements through the retaining holes and the locking holes. Furthermore, a sensor is fixed on an engagement element of the base; the sensor is used for detecting, receiving and affirming whether a label paper is drawn out and taken away after a transfer printing is completed so as to convey and execute the next paper feeding command.

The main object of the present invention is to provide a cut device of a label printer, fixing a fixed type cutting tool on a base and indenting an accepting space for receiving an acting mechanism; the acting mechanism comprises a pressing element, an elastic element installed under the fixing portion of the pressing element and a connecting element passed through the elastic element to fixing portion of the pressing element and locked thereto; a bottom of the connecting element is connected to a center position of a movable cutting tool, thereby exerting a uniform force on the movable cutting tool while the acting mechanism is pressed and allowing the movable cutting tool to carry out a stable movement so as to increase the life of the movable cutting tool and the acting mechanism; besides, the acting mechanism is simple and the assembly thereof is easy. Therefore, the production efficiency can be increased effectively.

Another object of the present invention is to provide a cut device of a label printer, configuring at least two locking holes on a front end of a main body of the label printer, and extending a fixing portion on left and right ends of a lower housing plate; retaining holes are disposed on the fixing portion, the cut device can be installed in front of the main body of any kind of label printer by passing locking elements through the retaining holes and the locking holes of the main body, allowing the cut device to be replaced conveniently.

### BRIEF DESCRIPTION OF THE DRAWINGS

The present invention can be more fully understood by reference to the following description and accompanying drawings, in which:

FIG. 1 is an exploded view of a main body and a cut device of the present invention;

FIG. 2 is an exploded view of a cut device of the present invention;

FIG. 3 is a rear side view of a cut device assembly of the present invention;

FIG. 4 is a schematic view of a preferred embodiment of the present invention;

FIG. 5 is a schematic view of an action of a cut device;

FIG. 6 is a schematic view of another action of a cut device of the present invention; and

FIG. 7 is a partly schematic view of a cut device of the embodiment according to the present invention.

### DETAILED DESCRIPTION OF THE PREFERRED EMBODIMENTS

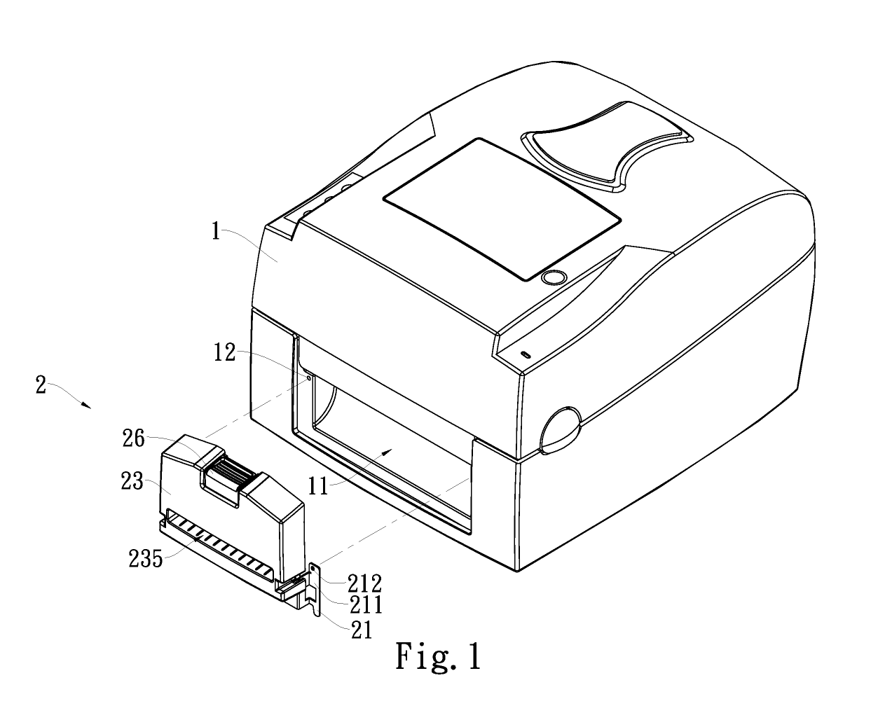

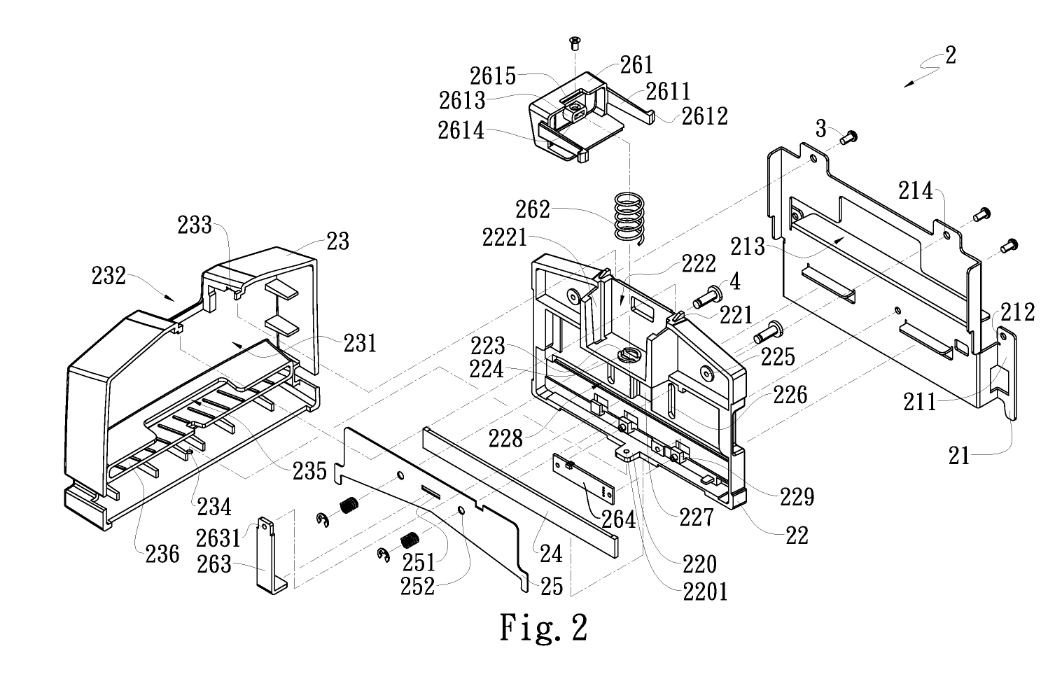

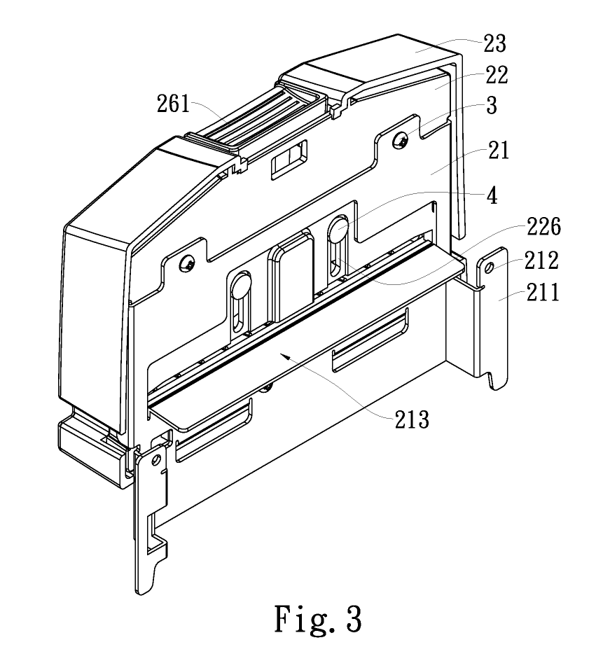

Please refer to FIGS. 1 to 3. A cut device of a label printer of the present invention is a cut device installed in front of a main body of the label printer, the front end of the main body 1 has a paper outputting exit 11, at least two locking holes 12 adjacent to the paper outputting exit 11, used for installing the cut device 2 at the paper outputting exit 11. The cut device 2 mainly includes a lower housing plate 21, a upper cover plate 23, a fixed type cutting tool 24, a movable cutting tool 25 and an acting mechanism 26.

Two sides of the lower housing plate 21 are respectively extended with a fixing portion 211 with a retaining hole 212 disposed thereon, the lower housing plate 21 and the main body 1 are connected and fixed to each other by passing a locking element through each retaining hole 212 and the corresponding locking hole 12 of the main body 1 to lock them together. Furthermore, a paper outputting exit 213, used for guiding label papers into the base 22, is opened on the face of the lower housing plate 21, and at least one through hole 214, allowing a locking element 3 to be passed through it to connect to the base 22, is disposed on the upper end of the lower housing plate 21.

The base 22 is installed in front of the lower housing plate 21, the bottom end thereof is extended outward with a fixing element 20 and a locking hole 2201 disposed on the fixing element 2201. Furthermore, two fixing elements 221 are projected from the top end of the base 22, and one accepting space 222, used for receiving the acting mechanism 26 is indented between the two fixing element 221. Besides, symmetrical grooves 2221 are disposed in the accepting space 222, each groove 2221 is extended and passed through to the bottom of the accepting space 222, and a slot 223 is disposed on the central position of the bottom of the accepting space 222, where a positioning projection 224, used for controlling the stroke of the acting mechanism 26, is disposed above the slot 223; a locking hole 225 corresponding to each through hole 214 of the lower housing plate 21 is disposed on the face of the base 22, and the base 22 and the lower housing plate 21 are connected and fixed together by passing a locking element 3 through each aforementioned through hole and corresponding locking hole 225, furthermore, two symmetrical skid rail grooves 226 are disposed on the face of base 22 and a sliding groove 227 is disposed between the two skid rail grooves 226. Besides, a long slot 228 perpendicular to the sliding groove 227 is disposed under the sliding groove 227, and the long slot 228 corresponds to the paper outputting exit 213 of the lower housing plate 21 so as to receive the label papers, and at least two buckling elements 229 used for buckling the fixed type cutting tool 24 are disposed with a planned distance under the long slot 228 of the base 22.

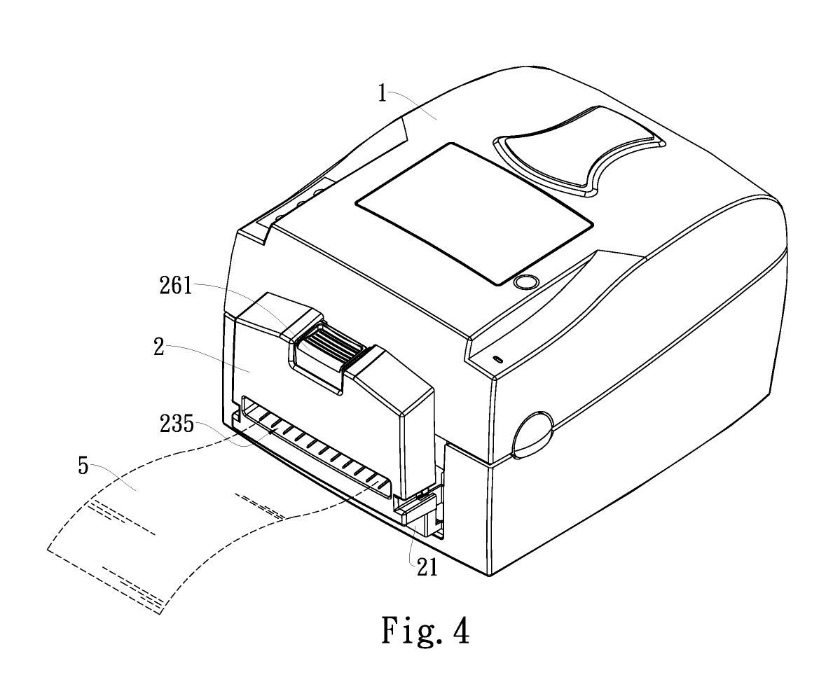

The upper cover plate 23 is put around the front end of the lower housing plate 21 and has an accepting space 231 used for receiving the base 22. The top end of the upper cover plate 23 is indented with a breach 232, and grooves 233 corresponding to the two fixing elements 221 of the base 22 are respectively disposed on the inner side face of breach 232 so as to allow them to be engaged with each other. A through hole 234 is opened at a proper position of the bottom of the upper cover plate 23, and a locking element is passed through the through hole 234 and inserted to the locking hole 2201 of the base 22 and locked therein, thereby connecting the base 22 to the upper cover plate 23. An opening 235 corresponding to the long slot 228 of the base 22 is open on the face of the upper cover plate 23, and the rim of the opening 235 is extended toward a direction with an auxiliary frame 236, assuring that the smooth output of label papers as FIG. 4 shows.

The fixed type cutting tool 24 is installed below the long slot 228 of the base 22 and buckled by the buckling element 229.

The movable cutting tool 25 is installed below the accepting space 222 of the base 22 and positioned above the long slot 228, thereby connecting with the acting mechanism 24, and the movable cutting tool 25 has a slot 251 and opened with one hole 252 corresponding to each skid rail groove 226, thereby locking the movable cutting tool 25 to the base 22 by passing a locking element 4 through each skid rail groove 22 and then into the corresponding hole 252. Furthermore, the movable cutting tool 25 can carry out perpendicular action sliding through the configuration of the skid rail groove 226.

The acting mechanism 26 includes a pressing element 261, an elastic element 262, a connecting element 263 and a sensor 264, where the pressing element 261 is received in the accepting space of the base 22, two sides thereof are respectively extended with a clipping portion 2611, and the end of each clipping portion 3611 is formed with a hook 2612, thereby allowing the clipping portion 2611 to be received in the groove 2221 of the base and the hooks 2612 to be passed out of the bottom of the accepting space and hold up each other at the bottom to cause the pressing element 261 to be engaged and fixed in the base 22 when the pressing element 261 is installed on the base 22. The inner side of the pressing element 261 is disposed with a fixing portion 2613 capable of being put around with the elastic element 262, and the bottom of the elastic element 262 is put around the positioning projection 224 of the base 22. Furthermore, the base of the pressing element 261 is disposed with a slot 2614 capable of being passed through and put around with the top end of the connecting element 263, and a proper position of the outside thereof is disposed with a screw hole 2615 used for fixing the connecting element 263. The connecting element 263 is a L-shaped body, the upper end thereof is opened with an axial hole 2631, the connecting element 263 is fixed to the pressing element 261 by passing a locking element through the screw hole 2614 and the axial hole 2631 of the connecting element 263 when the connecting element 263 is passed through the slot 223 of the base 22, the elastic element 262 and into the slot 2614 of the bottom of the fixing portion 2613 of the pressing element 261. Furthermore, the bottom of the connecting element 263 is passed through the slot 231 of the movable cutting tool 235 thereby being connected with the movable cutting tool 235 and driving the movable cutting tool 25. Furthermore, the sensor 264 is fixed to the buckling element 229 of the base 22, and used for detecting, receiving and ensuring whether the label paper 5 is drawn out or taken away after the transfer printing is completed so as to convey and execute the next paper feeding command.

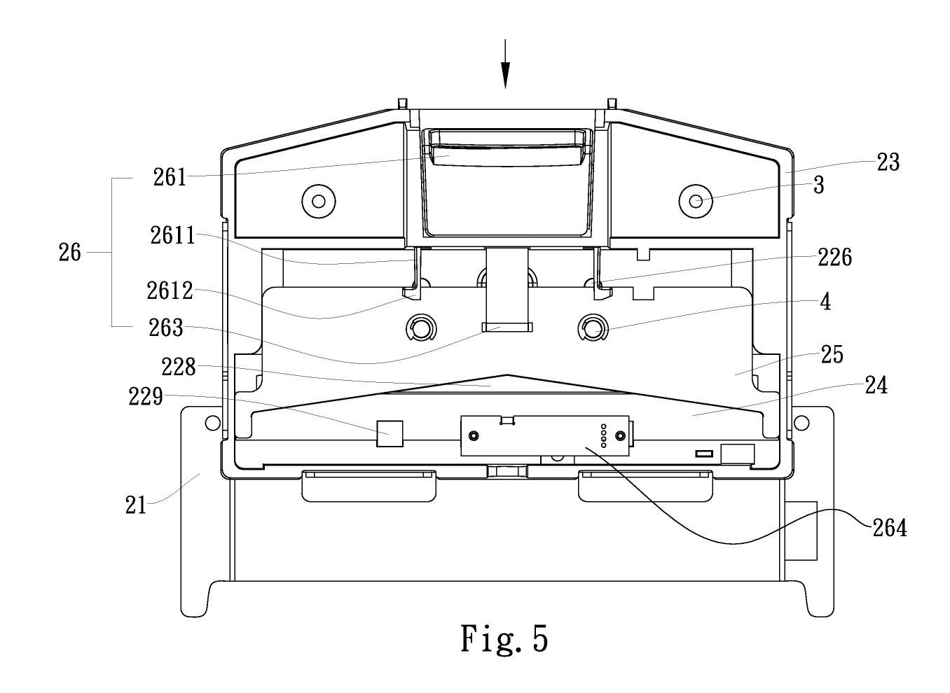

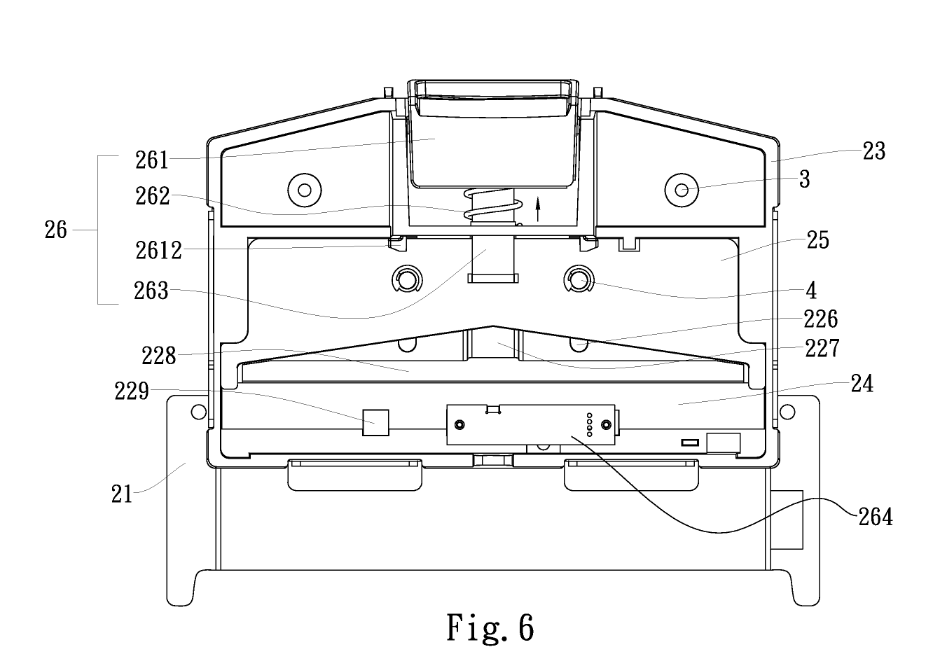

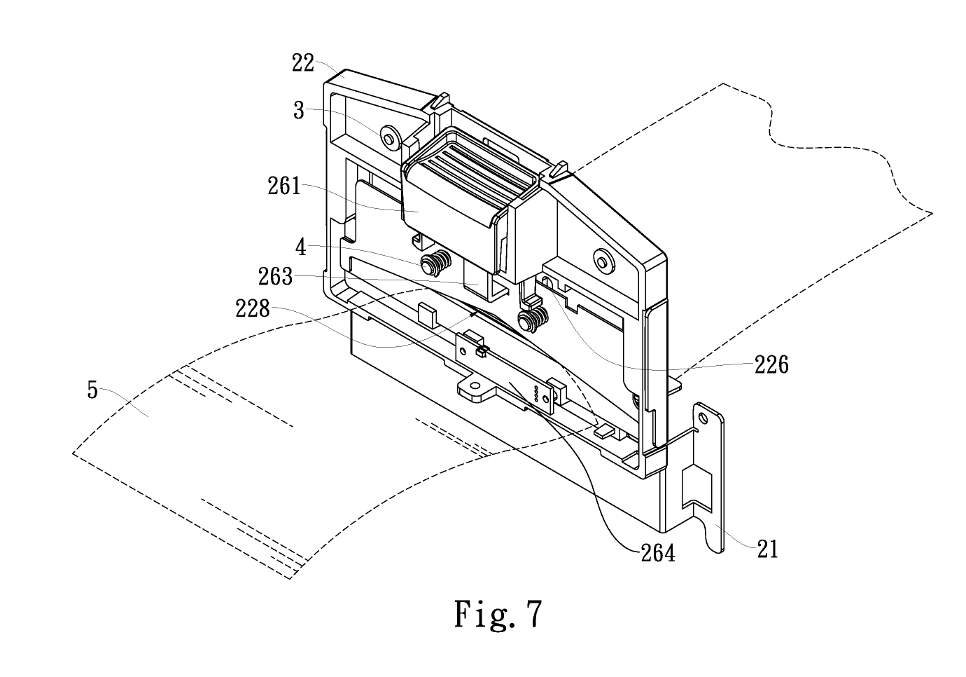

Please refer to FIGS. 4 and 7. FIGS. 4 and 7 are schematic views of a cut device for a label printer of a preferred embodiment according to the present invention. The label paper 5 is output from the paper outputting exit 11 of the main body 1 into the long slot 228 of the base 22 after the label printing of the label printer as FIG. 7 shows, and conveyed to the opening portion 235 through the assistant frame 236 of the upper cover plate 23. When the label paper 5 is output, the clipping portion 2611 of the pressing element 261 is forced to slide downward along the groove 2221 of the base 22 by exerting a operation force on the pressing element 261 of the acting mechanism 26 as FIG. 5 or 7 shows and the connecting element 263 is driven downward such that the movable cutting tool 25 carries out a downward action along the skid rail groove 227 of the base 22, causing the movable cutting tool 25 and the fixed type cutting tool 24 to contact with each other face to face to generate a cut function to cut the label paper 5 off. Thereafter, the pressing element 261 is recovered back to an original position through the elastic element 262 and the hook 2612 of the pressing element as FIG. 6 shows, thereby allowing the acting mechanism 26 to drive the movable cutting tool 25 to generate a vertical reciprocating motion to cut the label paper 5 every time the transfer printing of the label paper 5 is completed. Besides, it can be detected whether the label paper is drawn out or not after the completion of the transfer printing through the sensor 264, and a command can then be transmitted to execute a next paper feeding action. Furthermore, the cut device 2 of the present invention can be installed in front of any kind of main body 1 such that a customer's burden can be reduced, and the cut device 2 can also cut the label paper 5 completely effectively even after a long term use.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cut device for a label print, being a cut device installed in front of a main body of a label printer, comprising a lower housing plate, a base, a upper cover plate, a fixed type cutting tool, a movable cutting tool and an acting mechanism; wherein
said lower housing is opened with a paper outputting exit;
said base is fixed on said lower housing plate, a top end thereof is indented with
an accepting space, a long slot is opened under said accepting space;
said acting mechanism is received in said accepting space of said base, comprises a pressing element, an elastic element and a connecting element, and a bottom of said connecting element is connected to said movable cutting tool;
said cover plate is fixed to said base, used for receiving said fixed type cutting tool, movable cutting and said acting mechanism between said upper cover plate and said base;
after a label paper is output from said main body to said long slot of said base, said acting mechanism drives said movable cutting tool connected thereto to move downward to contact with said fixed type cutting tool face to face by pressing said acting mechanism such that said label paper is cut off.

2. The cut device for a label printer according to claim 1, wherein two sides of said lower housing plate are respectively extended with a fixing portion, a fixing hole is disposed on said fixing portion, said lower housing plate is locked to said main body by passing a locking element through said fixing hole.

3. The cut device for a label printer according to claim 2, wherein symmetrical grooves are disposed in said accepting space of said base, and said groove is extended and passed through to a bottom of said accepting space, and a slot is dispose on a central position of said bottom of said accepting space and an indentation portion is disposed above said slot.

4. The cut device for a label printer according to claim 3, wherein two symmetrical skid rail grooves perpendicular to said long slot of said base are opened above said long slot, and a sliding groove is opened between said two skid rail groove.

5. The cut device for a label printer according to claim 4, wherein at least two buckling elements are disposed with a planned distance under said long slot of said base.

6. The cut device for a label printer according to claim 5, wherein a sensor is respectively installed on said buckling element and used for receiving, sense whether said label paper is drawn out or not.

7. The cut device for a label printer according to claim 6, wherein a plurality of fixing elements used for engaging with and fixing to said base.

8. The cut device for a label printer according to claim 7, wherein said movable cutting tool has a slot, and holes respectively correspond to the two skid rail grooves of said base, said movable cutting tool is locked in said base by passing a locking element through each skid rail groove and into said corresponding hole.

9. The cut device for a label printer according to claim 8, wherein a fixing portion used for putting said elastic element around said pressing element of said acting mechanism is disposed on an inner side of said pressing element, and a bottom of said pressing element is put around said positioning projection of said base, a slot allowing a top end of said connecting element to be passed through and engaged with said slot is disposed on a bottom of said pressing element, and a screw hole used for fixing said connecting element is dispose at a proper position of an outer side of said pressing element.

10. The cut device for a label printer according to claim 1, wherein a fixing portion used for putting said elastic element around said pressing element of said acting mechanism is disposed on an inner side of said pressing element, and a bottom of said pressing element is put around said positioning projection of said base, a slot allowing a top end of said connecting element to be passed through and engaged with said slot is disposed on a bottom of said pressing element, and a screw hole used for fixing said connecting element is dispose at a proper position of an outer side of said pressing element.

11. The cut device for a label printer according to claim 8, wherein a fixing portion used for putting said elastic element around said pressing element of said acting mechanism is disposed on an inner side of said pressing element, and a bottom of said pressing element is put around said positioning projection of said base, a slot allowing a top end of said connecting element to be passed through and engaged with said slot is disposed on a bottom of said pressing element, and a screw hole used for fixing said connecting element is dispose at a proper position of an outer side of said pressing element.

12. The cut device for a label printer according to claim 11, wherein a clipping portion is respectively disposed on two sides of said pressing element, an end thereof is a hook type body, allowing said clipping portion to slide in said groove of said base, said clipping portion and a bottom of said accepting space of said base hold up each other by passing said hook type bode through said groove.

13. The cut device for a label printer according to claim 12, wherein said connecting element of said acting mechanism is a L-shaped body, an upper end thereof is opened with an axial hole used for connecting with said fixing portion of said pressing element.

14. The cut device for a label printer according to claim 13, wherein said upper cover plate has an accepting space used for receiving said base, an opening corresponding to said long slot of said base is opened on a face of said upper plate, and a rim of said opening is extended toward a direction to form an auxiliary frame.

15. The cut device for a label printer according to claim 14, wherein a top end of said upper cover plate is indented with a breach, grooves respectively corresponding to said two fixing elements of said base are disposed on an inner face of said breach so as to be convenient for engaging said upper cover plate with said base.
